(19) United States
(12) Patent Application Publication
(10) Pub. No.: US 2004/0078436 A1
(43) Pub. Date: Apr. 22, 2004

(54) Adding meeting information to a meeting notice

(75) Inventors: Scott H. Demsky, Boca Raton, FL (US); Robert M. Szabo, Boca Raton, FL (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: International Business Machines Corporation, Armonk, NY

(21) Appl. No.: 10/273,768

(22) Filed: Oct. 18, 2002

(51) Int. Cl. G06F 15/16

(52) U.S. Cl. 709/206; 709/245

(57) ABSTRACT

Within an electronic meeting notification system, a method of scheduling meetings can include storing meeting attribute information within a user profile of the meeting notification system and receiving a user request to schedule a meeting. A user can be prompted whether to automatically include at least a portion of the meeting attribute information within a meeting notification to be distributed to meeting participants.

### BACKGROUND

1. Field of the Invention

The present invention relates to the field of electronic meeting notification systems and, more particularly, to arranging meetings through such systems.

2. Description of the Related Art

The advent of multi-party electronic meeting notification systems, such as Lotus Notes™ which is available from International Business Machines Corporation, facilitates the scheduling of multi-party meetings by determining whether prospective meeting participants are available at designated times, sending invitations to join meetings to designated recipients, scheduling an agreed upon meeting time, meeting duration, and date within each participant's individual calendar, and performing other collaborative functions.

Presently, when scheduling a meeting, a user typically initiates a request to schedule a meeting with the electronic meeting notification system. The user manually enters information about the meeting such as the subject of the meeting, the location of the meeting, or any other pertinent detail describing the purpose, setting, and context of the meeting. The meeting information is entered within a notification to be distributed to the meeting participants. Notably, in cases where one or more users have a need for recurring, periodic, or aperiodic meetings, the user that schedules the meeting via the electronic meeting notification system must create meeting notifications for each scheduled meeting within a chain of related meetings. The user also must enter any other pertinent information describing the meeting into the meeting notification in a manual fashion.

If the scheduled meeting is to coincide with a teleconference, the meeting information also must specify teleconference specific information such as local call-in numbers, tie-line numbers, toll or toll-free call-in numbers, any necessary passwords for participating in the meeting, and the like. Although many service providers make perpetual call-in numbers available to registered users at any time of day, users still must manually type such call-in information into meeting notifications. In consequence, users must expend significant time arranging meetings through electronic meeting notification systems, thereby increasing the cost of doing business.

### SUMMARY OF THE INVENTION

The invention disclosed herein provides a method and apparatus for arranging meetings through an electronic meeting notification system. The present invention can be used in the context of a calendaring system, a scheduling system, an electronic mail system, or other communication and/or collaborative system through which users can schedule or notify others of meetings. Tasks which had previously been performed manually by a user when arranging a meeting can be automated through the electronic meeting notification system.

The present invention enables a user to specify one or more meeting attributes within a user profile. Accordingly, when a user initiates a meeting, any of the predetermined meeting attributes can be included automatically within the meeting notification being generated by the electronic meeting notification system, thereby relieving the user from having to manually include or specify such information each time a meeting is scheduled. The present invention can provide significant savings with regard to both time and effort, especially within the context of arranging recurring meetings.

One aspect of the present invention can include a method of scheduling meetings within an electronic meeting notification system. The method can include storing meeting attribute information within a user profile of the meeting notification system and receiving a user request to schedule a meeting. The method further can include prompting a user whether to include at least a portion of the meeting attribute information within a meeting notification to be distributed to meeting participants.

The meeting attribute information can specify perpetual teleconference information. The perpetual teleconference information can specify instructions for accessing a teleconference which is to take place during the meeting. The instructions can include one or more perpetual teleconference numbers for connecting to the teleconference as well as any required passwords. The meeting attribute information also can include perpetual electronic meeting information pertaining to an electronic meeting to take place during the meeting. The perpetual electronic meeting information can specify at least a perpetual electronic meeting address at which the electronic meeting can be accessed.

Still, the meeting attribute information can include additional information pertaining to the meeting such as the preferred attire for the meeting, a meeting location, as well as a topic for the meeting. It should be appreciated, however, that any other information pertaining to the purpose, setting, and/or context of the meeting can be specified as meeting attribute information.

A request to automatically include at least a portion of the meeting attribute information within the meeting notification can be received. Accordingly, any user specified meeting attribute information can be retrieved from the user profile. The meeting notification can be generated and the user specified meeting attribute information can be included automatically within the meeting notification. The method further can include receiving a user input which designates at least one meeting participant to which the meeting notification is to be distributed and distributing the meeting notification to the designated meeting participants.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a flow chart illustrating a method of arranging a meeting in accordance with the present invention.

FIG. 2 is a schematic diagram illustrating a view of a graphical user interface for use with the present invention.

FIG. 3 is a schematic diagram illustrating another view of the graphical user interface of FIG. 2.

FIG. 4 is a schematic diagram illustrating another view of the graphical user interface of FIG. 2.

FIG. 5 is a schematic diagram illustrating the view of FIG. 2 wherein the view has been populated with meeting attribute information.

### DETAILED DESCRIPTION OF THE INVENTION

The invention disclosed herein provides a method and apparatus for arranging meetings through an electronic meeting notification system. Through the present invention, any of a variety of predetermined meeting attributes can be designated for inclusion within a meeting notification to be distributed to one or more meeting participants. The meeting attributes can be defined within a user profile maintained as part of the electronic meeting notification system. Accordingly, the user is relieved from manually specifying meeting attributes each time a meeting notification is generated.

The present invention associates each user intending to participate in or schedule meetings using the electronic meeting notification system with a user profile. In addition to specifying conventional information within the user profile such as contact information, user names, permissions, and the like, the user profiles also can include meeting attribute information. In particular, users can specify one or more attributes relating to one or more individual meetings as well as groups of related, recurring, periodic, or aperiodic meetings. The meeting attributes can specify information ranging from the type of attire a meeting owner expects to be worn at the meeting, the subject matter of the meeting, the meeting time, location, or any other information relating to the meeting. The user profiles, or at least the meeting attribute information specified by the user profiles, can be edited by users, for example through an interface of the electronic meeting notification system. The user profiles can be stored within one or more data stores which are included within, or are accessible by the electronic meeting notification system.

According to one embodiment of the present invention, the meeting attribute information specified within a user profile can include perpetual teleconference information. The term “perpetual teleconference”, as used herein with reference to dial-in numbers and information, refers to the provisioning or availability of one or more telephone numbers from a service provider to an authorized user. A perpetual teleconference number, for example, can be a dial-in number that is assigned to a user for a fixed or predetermined time period. The perpetual teleconference number also can be made available to a user for as long as the user maintains an account in good standing with the service provider. The perpetual teleconference number is available to the user and any other parties to which the user provides the perpetual teleconference information (i.e. the dial-in numbers, passwords, and the like).

In the case where a scheduled meeting is to coincide with a teleconference, relevant information for joining the teleconference can be included within the meeting notice as extracted from the user profile. For example, perpetual teleconference information can include instructions for accessing the teleconference including one or more designated perpetual teleconference numbers, whether tie-line numbers, local numbers, international numbers, toll numbers, toll-free numbers, and the like. The instructions also can designate a third party teleconference service provider, any passwords, and/or other information necessary for participants to access or connect to the teleconference.

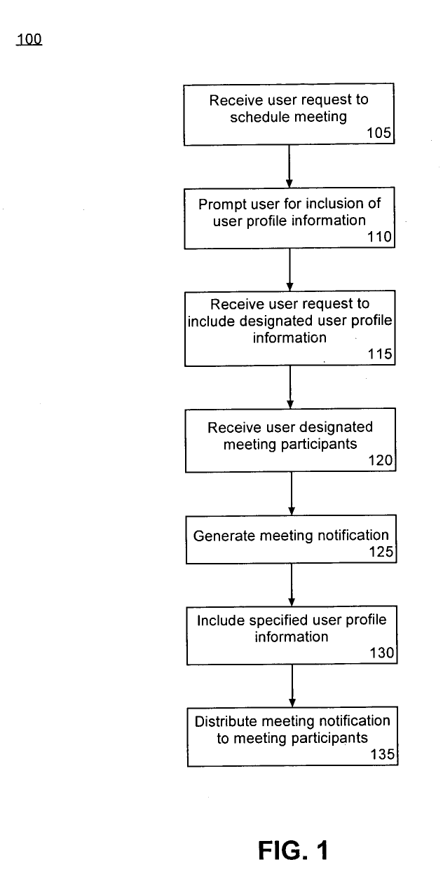

FIG. 1 is a flow chart illustrating a method 100 for arranging a meeting in accordance with the inventive arrangements disclosed herein. The method 100 can be performed in the context of interacting with an electronic meeting notification system as previously described. The method 100 can begin in step 105 where a user request to schedule a meeting is received. Whether from one or more voice commands, keyboard commands, or pointer selections, the user can initiate a request to schedule a meeting with the electronic meeting notification system. For example, the user can select a schedule meeting option or initiate an electronic mail or other communication from within the electronic meeting notification system.

In step 110, the electronic meeting notification system can prompt the user as to whether any meeting attribute information from the user's profile is to be included within the meeting notification being constructed. As such, the electronic meeting notification system provides the user with an opportunity to designate one or more meeting attributes. For example, the user can be provided one or more possible meeting attribute selections derived from the user's profile from which to choose. Alternatively, the user can be queried as to which attributes, if any, are to be included within a meeting notification being generated. Notably, the meeting attribute information can be categorized into collections of one or more individual attributes, thereby enabling the selection of a collection of attributes for a meeting notification. For example, each collection of meeting attributes can coincide with a particular meeting, chain of related meetings, one or more perpetual teleconference numbers, and/or one or more perpetual electronic meeting addresses or spaces.

In step 115, the electronic meeting notification system can receive a user request to include one or more designated meeting attributes. The request can specify one or more individual meeting attributes or a collection of attributes from the user profile. For example, particular meeting attributes to be included within the meeting notification can be identified from a user spoken utterance specifying the individual attributes or an attribute collection name, or from one or more user selections as specified within a graphical user interface (GUI). In step 120, the electronic meeting notification system can identify one or more meeting participants to which the meeting notification is to be sent. For example, the electronic meeting notification system can receive a further user input as noted which specifies the meeting participants. Notably, the meeting participants can be specified as one or more individuals or as a grouping or classification of more than one individual within an organization, for example as may be specified within an electronic address book.

In step 125, a meeting notification can be generated. For example, if a user had been interacting with a series of GUIs of the electronic meeting notification system, an electronic communication such as an instant message or an electronic mail message can be generated using a designated communications protocol. The user specified meeting attributes can be included within the electronic meeting notice under construction in step 130. That is, user specified meeting attribute information can be identified within a user profile, copied from the user profile, and inserted into the meeting notification, for example via an electronic meeting notification client.

Thus, in step 135, the meeting notice can be distributed to the designated meeting participants. Notably, the meeting notice can be distributed by any of a variety of different techniques. For example, the meeting notice can be sent via electronic mail, instant message, or by another communications protocol via a central messaging or notification processor or server. The meeting notification can be distributed directly to meeting participant devices or to a network location assigned to each of the meeting participants such that receiving participants are notified, for example via the electronic meeting notification system clients. The notification also can be published to a central location that is accessible to the meeting participants such that each meeting participant can consult the central location periodically, for example via the electronic meeting notification system clients.

Those skilled in the art will recognize that the steps disclosed with reference to FIG. 1 need not be performed in a particular order. For example, many of the user designated data and meeting attributes to be used in generating a meeting notification can be specified in varying order through a single unified meeting notification GUI.

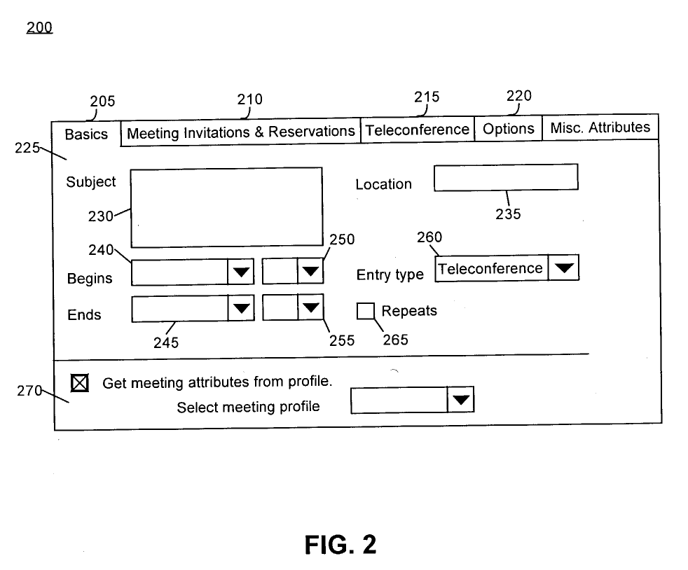

FIGS. 2, 3, and 4 are schematic diagrams illustrating exemplary views of a GUI 200 which can be used with the electronic meeting notification system to specify meeting attributes. The selected fields, selector mechanisms, and data which can be specified within the views presented in FIGS. 2, 3, and 4 can be populated or configured automatically according to user specified meeting attribute information derived from a user profile. More particularly, a user can select one or more attributes individually or a grouping of attributes which are used to automatically populate or configure selected portions of the various views disclosed herein. Accordingly, meeting attribute information derived from a user profile can be inserted automatically into a meeting notification to be distributed to the meeting participants.

FIG. 2 is a schematic diagram illustrating an exemplary view 225 of the GUI 200 which can be used to specify various meeting attributes. More particularly, the GUI 200 can be used in conjunction with the electronic meeting notification system described herein. The GUI 200 can include several tabs 205, 210, 215, and 220 for selecting particular views of the GUI 200. As shown, tab 205, entitled “Basic” has been selected, and accordingly, the view 225 which is associated with tab 205 is depicted. View 225 allows a user to specify basic meeting attributes. Thus, a subject field 230 and a location field 235 are provided through which a user can specify subject and location information respectively.

The GUI 200 also can include a date selection mechanism 240 and 245 for specifying the beginning and ending date of a meeting. Time selection mechanisms 250 and 255 can be provided for specifying beginning and ending meeting times as well. Selection box 260 allows a user to specify an entry type. For example, if the meeting being scheduled is to be a teleconference, that is a teleconference is to occur concurrently with the meeting, then the user can select the teleconference option as shown. Further details regarding the teleconference can be specified in another view associated with the “Teleconference” tab 215. Check box 265 allows a user to specify whether the meeting is to repeat. For example, responsive to selecting check box 265, additional selections can be presented for specifying additional meeting times, meeting frequency, and the number of recurring meetings associated with the meeting being scheduled.

Segment 270 allows a user to specify whether meeting attributes is to be extracted from a user profile rather than the user having to manually specify the information. Responsive to selection of the “Get meeting attributes from profile” option, the select meeting profile option and selection box can be activated. Accordingly, through the selection box, a user can select a portion of the user's individual profile. For example, the user can select a meeting attribute or a collection of attributes from his or her individual user profile. Responsive to selecting one or more meeting attributes, as will be described herein in greater detail, various fields of the GUI 200 can be populated with information derived from the user's profile.

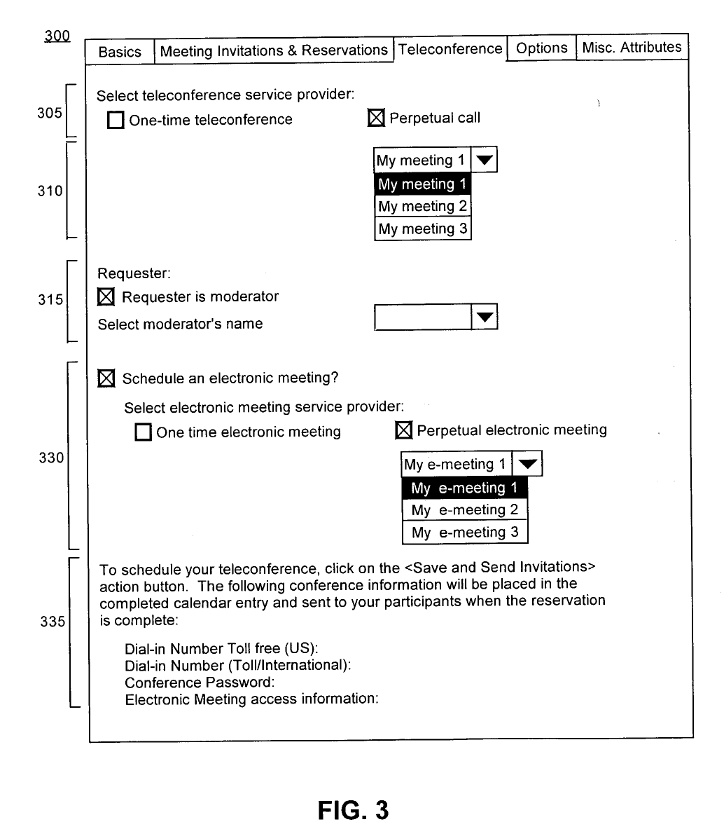

FIG. 3 is a schematic diagram illustrating a view 300 of the GUI of FIG. 2. More particularly, view 300 depicts the teleconference setup portion of the GUI 200. The view 300 can include one or more segments 305, 310, 315, and 330 which enable a meeting participant to request a one-time teleconference, specify one or more perpetual teleconference numbers, specify a moderator, as well as request a one time electronic meeting or a perpetual electronic meeting. Notably, segment 335 can indicate any perpetual teleconference information including, but not limited to, a dial-in number for the teleconference to be used by meeting participants located within the U.S.A., a dial-in number for the teleconference to be used by meeting participants located outside of the U.S.A., a teleconference password, and any necessary electronic meeting access information.

In segment 305, a user can request a one time teleconference or a perpetual teleconference number. For example, if the user selects the one-time teleconference option, the user can be prompted for additional information which may be required for arranging the one-time teleconference (not shown). Upon selecting the perpetual teleconference option, the drop-down menu of segment 310 can be enabled, or rendered active, and can be populated with one or more perpetual teleconference data sets specified by the user's electronic meeting notification system profile. For example, the selected “My meeting 1” option can specify one or more particular perpetual teleconference numbers and instructions for accessing the perpetual teleconference number including passwords. Each option can specify a set of one or more perpetual teleconference numbers, for instance a toll-free number, a toll-number, and a tie-line number. While each perpetual teleconference data set specified by a user profile can include perpetual teleconference numbers and access codes, such information also can specify one or more preferred attributes which can be used to populate the remainder of the fields of view 300.

In segment 330, a user can request a one-time electronic meeting, referred to as an “e-meeting”, or a perpetual electronic meeting. An electronic meeting enables participants to view common images as if each person was located at the same location and viewing the same display. Electronic meeting systems, such as Lotus Sametime™, available from International Business Machines Corporation of Armonk, N.Y., can provide an electronic meeting place, for example specified as a uniform resource locator (URL), an IP address, or other suitable address for accessing the electronic meeting. Electronic meeting systems enable meeting owners to control which images are shown to the other electronic meeting participants. Perpetual electronic meeting spaces can be allocated to users similar to the way in which perpetual teleconference numbers can be arranged.

Accordingly, in segment 330, if the user requests the one-time electronic meeting option, the user can be prompted for additional information which may be required for arranging the one-time electronic meeting (not shown). If the use selects the perpetual electronic meeting option, the drop down menu portion of segment 330 can be enabled and populated with one or more perpetual electronic meeting data sets as specified in the user's electronic meeting notification system profile. Similar to the perpetual teleconference data sets, the perpetual electronic meeting data sets can specify an address for the electronic meeting as well as any access instructions including access codes and the like.

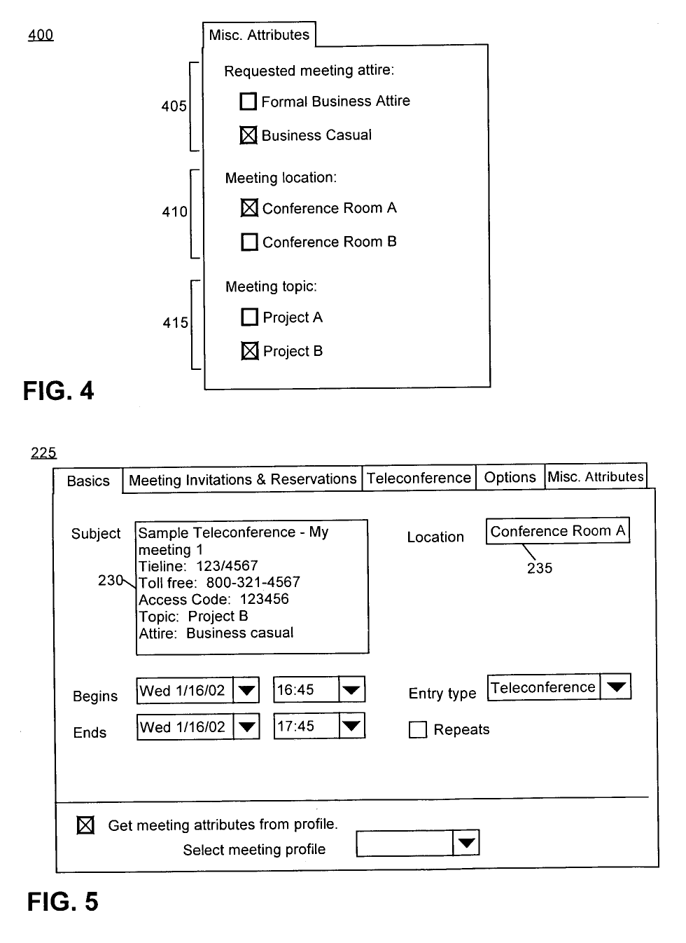

FIG. 4 is a schematic diagram illustrating a view 400 which is incorporated into the GUI 200 of FIG. 2. As shown, the view 400 can be referred to as a “Miscellaneous Attributes” view wherein a user can specify one or more additional parameters regarding the meeting currently being scheduled. In segment 405, the user can specify a type of business attire which is expected at the meeting. In segment 410, the user can specify a location of the meeting, for example “Conference Room A”. In segment 415, the user can select a meeting topic. As not all meeting attributes are relevant for all meeting types, particular attributes can be selectively enabled and disabled depending upon whether a meeting is to be a teleconference, a live meeting, or a video conference. For example, one or both of segments 405 and 410 can be disabled for teleconferences if so desired. Additionally, it should be appreciated that the attributes illustrated in FIG. 4 can be displayed or presented in any of a variety of different graphical formats using one or more different views.

FIG. 5 is an illustration of view 225 of FIG. 2, wherein the user has specified a meeting location, a perpetual teleconference data set, a meeting topic, as well as meeting times and dates. More particularly, field 230 has been automatically populated with the perpetual teleconference information specified in the “My meeting 1” data set. Field 235 has been automatically populated with the meeting location information “Conference Room A” as specified in the attributes view of FIG. 4. Thus, the user has been relieved from having to manually type the data into the meeting notification. As shown, the data set specifies a tieline number, a toll-free number, and an access code. A topic for the meeting and a preferred style of business attire also have been inserted in field 230 automatically, as specified from the attributes view. Notably, if an electronic meeting had been requested, then information corresponding to the perpetual electronic meeting, for example, access codes, IP addresses, URLs, other addressing information, and/or instructions could be inserted automatically into field 230 or another field suited for displaying such information.

The various GUIs disclosed herein are shown for purposes of illustration only. Accordingly, the present invention is not limited by the particular GUI or data entry mechanisms contained within views of the GUI. Rather, those skilled in the art will recognize that any of a variety of different GUI types and arrangements of data entry fields, selectors, and controls can be used.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. Within an electronic meeting notification system, a method of scheduling meetings comprising:
storing meeting attribute information within a user profile of the meeting notification system;
receiving a user request to schedule a meeting; and
prompting a user whether to automatically include at least a portion of the meeting attribute information within a meeting notification to be distributed to meeting participants.

2. The method of claim 1, wherein the meeting attribute information specifies perpetual teleconference information pertaining to a teleconference to take place during the meeting.

3. The method of claim 2, wherein the perpetual teleconference information specifies instructions for accessing the teleconference including at least one perpetual teleconference number for connecting to the teleconference.

4. The method of claim 1, wherein the meeting attribute information specifies perpetual electronic meeting information pertaining to an electronic meeting to take place during the meeting.

5. The method of claim 4, wherein the perpetual electronic meeting information specifies at least a perpetual electronic meeting address at which the electronic meeting can be accessed.

6. The method of claim 1, wherein the meeting attribute information specifies at least one of preferred attire for the meeting, a meeting location, and a topic for the meeting.

7. The method of claim 1, further comprising:
receiving a request to include at least a portion of the meeting attribute information within the meeting notification;
retrieving the user specified meeting attribute information from the user profile;
generating the meeting notification; and
automatically including the user specified meeting attribute information within the meeting notification.

8. The method of claim 6, further comprising:
receiving a user input designating at least one meeting participant to which the meeting notification is to be distributed.

9. The method of claim 8, further comprising:
distributing the meeting notification to the designated meeting participants.

10. A machine-readable storage, having stored thereon a computer program having a plurality of code sections executable by a machine for causing the machine to perform the steps of:
storing meeting attribute information within a user profile of the meeting notification system;
receiving a user request to schedule a meeting; and
prompting a user whether to automatically include at least a portion of the meeting attribute information within a meeting notification to be distributed to meeting participants.

11. The machine-readable storage of claim 10, wherein the meeting attribute information specifies perpetual teleconference information pertaining to a teleconference to take place during the meeting.

12. The machine-readable storage of claim 11, wherein the perpetual teleconference information specifies instructions for accessing the teleconference including at least one perpetual teleconference number for connecting to the teleconference.

13. The machine-readable storage of claim 10, wherein the meeting attribute information specifies perpetual electronic meeting information pertaining to an electronic meeting to take place during the meeting.

14. The machine-readable storage of claim 13, wherein the perpetual electronic meeting information specifies at least a perpetual electronic meeting address at which the electronic meeting can be accessed.

15. The machine-readable storage of claim 10, wherein the meeting attribute information specifies at least one of preferred attire for the meeting, a meeting location, and a topic for the meeting.

16. The machine-readable storage of claim 10, further comprising:
receiving a request to include at least a portion of the meeting attribute information within the meeting notification;
retrieving the user specified meeting attribute information from the user profile;
generating the meeting notification; and
automatically including the user specified meeting attribute information within the meeting notification.

17. The machine-readable storage of claim 16, further comprising:
receiving a user input designating at least one meeting participant to which the meeting notification is to be distributed.

18. The machine-readable storage of claim 17, further comprising:
distributing the meeting notification to the designated meeting participants.
